(19) United States
(12) Patent Application Publication
(10) Pub. No.: US 2018/0026246 A1
(43) Pub. Date: Jan. 25, 2018

(54) CAP FOR A BATTERY CELL

(71) Applicant: Froetek Vermoegensverwaltung GmbH, Osterode am Harz (DE)

(72) Inventors: Marcel DROESSLER, Sonnenstein (DE); Jan Hagen VOIGT, Gifhorn (DE); Sebastian MATHES, Kalefeld (DE)

(21) Appl. No.: 15/655,966

(22) Filed: Jul. 21, 2017

(30) Foreign Application Priority Data
Jul. 22, 2016 (DE) 102016008787.0

(51) Int. Cl. H01M 2/12; H01M 2/04

(52) U.S. Cl. CPC H01M 2/1252; H01M 2/04; H01M 2220/20; H01M 2220/10

(57) ABSTRACT

A battery cap of a battery has a cap body adapted to cover the battery and formed with a gas-discharge port for gas generated in the battery. The body is formed with a gas-discharge passage opening laterally into the gas-discharge port, a gas-vent plug having an inner side exposed to gases in the battery and formed with a passage have an inner end at the inner side and an outer end either opening laterally outwardly into the gas-discharge passage in a predetermined angular position of the plug or opening outwardly into the exterior.

### FIELD OF THE INVENTION

The present invention relates to a battery. More particularly this invention concerns a gas-venting cap for a cell-type battery.

### BACKGROUND OF THE INVENTION

A cell-type battery typically produces gas as a result of converting chemical energy into electricity. In addition such a battery typically needs to be filled at least once with a liquid, normally water, to initiate the electricity-producing chemical reaction.

Such a battery is typically used either as a drive batteries in an electric vehicle, in particular in an car or fork-lift truck to supply such a vehicle with power, or as a stationary batteries, in particular for uninterruptible current supplies or for interim storage of electrical power. They generally have a plurality of battery cells that are electrically connected to one another and are covered by a battery cap. The battery cap has, in addition to pole apertures, an opening for a water refilling connector through which gases produced in the battery cell can also escape.

### OBJECTS OF THE INVENTION

It is therefore an object of the present invention to provide an improved cap for a battery cell.

Another object is the provision of such an improved cap for a battery cell that allows different uses and by which, in particular, it is possible to determine where the gases produced in the battery cell flow.

### SUMMARY OF THE INVENTION

A battery cap of a battery has according to the invention a cap body adapted to cover the battery and formed with a gas-discharge port for gas generated in the battery. The body is formed with a gas-discharge passage opening laterally into the gas-discharge port, a gas-vent plug having an inner side exposed to gases in the battery and formed with a passage have an inner end at the inner side and an outer end either
opening laterally outwardly into the gas-discharge passage in a predetermined angular position of the plug or opening outwardly into the exterior.

In other words, the object is achieved according to the invention in that

a gas discharge passage which is connected to the gas-vent port is arranged in the battery cap,

a gas-vent plug, through the compartment of which the gas flows out, is sealingly seated in the gas-vent port,

the gas-vent plug has in its side wall at least one gas port which is connected to the gas discharge passage arranged in the battery cap or has an upper gas port through which the gas can proceed directly to the outside.

With such a gas-vent plug, the gases can be introduced into passages in the battery cap in order in particular to enter discharge hoses via these passages. In addition, or alternatively, the gas-vent plug has on its upper face at least one gas-outlet port, so that selectively the gas does not enter a passage, but proceeds to the outside. This selection takes place either in that the gas-vent plug has both a gas port in its side wall and also an upper gas-outlet port, or in that there are two different gas-vent plugs, one having only the lateral gas port and another one having only the upper gas-outlet port. In the first version, the selection is made by the different positions of the gas-vent plug in the battery cap. In the second version, the selection is made by the choice of the gas-vent plug.

It is particularly advantageous that the interior of the gas-vent plug has a compartment in which a gas-pervious filter body that fills the entire horizontal cross section of the compartment is snugly fitted. Thus, depending on requirement, the gas-vent plug can be used in the following four versions:

1. With an upper gas-outlet port without filter

2. With an upper gas-outlet port with filter

3. With a lateral port without filter

4. With a lateral port with filter

Thus, a considerable diversity of variants with the simplest structure and high functional reliability is available to the user of such a gas-vent plug or such gas-vent plugs.

In this case, it is particularly advantageous if the gas-vent plug has at least two working positions. In one position the through opening located in the side wall is connected to a gas discharge passage, and in a second position there is no connection to the gas discharge passage but there is a connection to the outside.

It is also proposed that a drop catcher covers the fill hole of the gas-vent plug and has a labyrinth-like gas-flow passage. The drop catcher is fastened underneath the gas-vent plug.

In order not to have to produce and use two differently configured gas-vent plugs, the gas-vent plug has in its side wall at least one gas port and has on its upper face at least one gas-outlet port, and the gas-vent plug is rotatably adjustable in the battery cap. In one angular position only the upwardly open gas port is open, and in the other angular position only the lateral gas-outlet port is uncovered.

### BRIEF DESCRIPTION OF THE DRAWING

The above and other objects, features, and advantages will become more readily apparent from the following description, reference being made to the accompanying drawing in which:

FIG. 1 is a top view of a battery-cell cap according to the invention;

FIG. 2 is a section taken along line II-II of FIG. 1;

FIG. 3 is a large-scale view of the detail indicated at III in FIG. 2;

FIG. 4 is a view like FIG. 3 of another embodiment of the cap; and

FIG. 5 is a large-scale view of the detail indicated at V in FIG. 4.

### SPECIFIC DESCRIPTION OF THE INVENTION

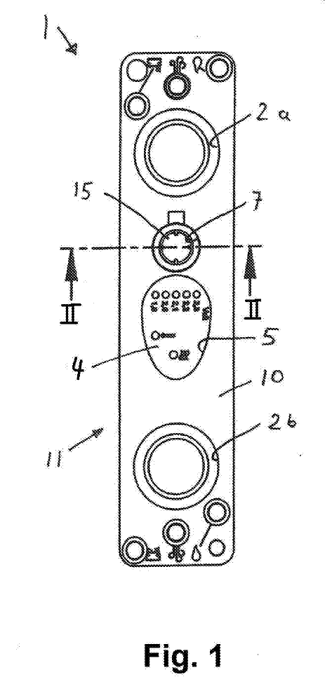

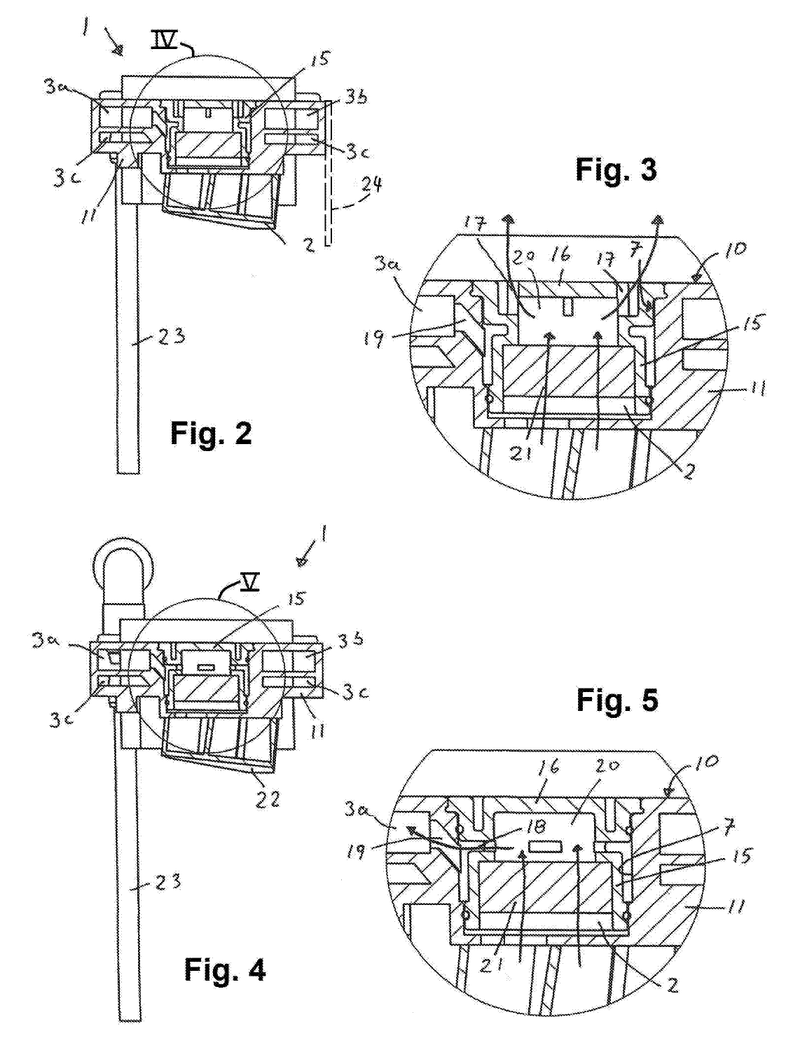

As seen in FIG. 1 a battery cap 1 according to the invention is used for covering the top of an individual battery cell of an industrial battery, in particular of a drive battery. It is made of plastic and has an elongated rectangular plate-shaped body 11 with a horizontal and planar upper face 10 whose length and width correspond to the length and width of the top of the battery cell shown schematically at 24 only in FIG. 2, so that the battery cap completely covers the battery cell.

At least one first pole opening 2a is provided in the plate 11 and opens at an upper face 10 thereof and at least one second pole opening 2b is provided at the other end and also opens at the upper face 10. A fill hole 5 in which a water refilling connector 4 is inserted is located between the two pole openings 2a and 2b in the plate 11 also opening at the upper face 10.

Passages 3a, 3b and 3c of rectangular cross section and whose walls are formed in the plate 11 are formed in the plate 11 below the upper face 10. The passage 3a serves for upwardly venting gas and is connected to a gas-venting opening 7 between the fill hole 5 and the pole opening 2a. The passage 3b serves for refilling with water and is connected to the water inlet 5 or to the water refilling connector W in the fill hole 5 and opens downward into the battery cell. The passages 3c run around the battery 1 cap on the underside and serve for supplying compressed air.

A vertical dip tube 23 extends downward from where it is anchored at the bottom of the battery cap 1 and projects into the electrolyte in the cell. Compressed air in the passage 3c exits from the lower end of this dip tube 23 in order to circulate the electrolyte.

As shown in FIGS. 2 and 3, gas-vent plug 15 fits complementarily and snugly into the gas-vent port 7 and is cylindrical over most of its height. The gas-vent plug 5 has an axially upwardly closed and downwardly open base 16, so that it has the shape of an inverted cup. FIGS. 2 and 3 show upwardly opening ports 17 formed in the base 16 and through which gas developing in the battery cell can escape upward.

In FIGS. 4 and 5, the base 16 has no upwardly open gas-outlet ports, but at least one laterally open gas-outlet port 18 connectable to the gas discharge passage 3a through a short connection passage 19 in the battery cap 1 is formed in the side wall of the gas-vent plug 15 and opening radially inwardly into the port 7. This connection exists only as long as the gas-vent plug 15 is in the correct angular position in which the opening 18 is aligned with the passage 19. In a different angular position this gas venting path to the passage 3a is closed.

The gas-vent plug has a compartment 20 that forms a seat 2 for a gas-pervious filter body 21 that fits tightly in the seat 2 or this part of the compartment 20 by positive engagement. The filter body 21 consists of glass, ceramic or sintered PE or PP, in order to let through gas and to prevent flashbacks into the battery 4.

A drop catcher 22 covers the fill hole of the gas-vent plug and has a labyrinth-like gas-flow passage. It is fastened underneath the gas-vent plug 15.

The gas-vent plug 15 is designed in two versions. In a first version with a lateral gas port 18 and in a second version with an upper gas-outlet port 17, so that by the choice of one of the two designs the gas venting takes place to the side into the passage 3a or upward to the atmosphere. In an embodiment which is not illustrated, the gas-vent plug 15 has both a lateral gas port 18 and also an upper gas-outlet port 17. In this case the cylindrical gas-vent plug 15 is rotatably adjustable about its vertical central axis in the cylindrical receptacle, so that the gas port 18 or the gas-outlet port 17 is opened selectively by rotary adjustment.

We claim:

1. A battery cap of a battery, the cap comprising:
a cap body adapted to cover the battery and formed with a gas-discharge port for gas generated in the battery, the body being formed with a gas-discharge passage opening laterally into the gas-discharge port;
a gas-vent plug having an inner side exposed to gases in the battery and formed with a passage have an inner end at the inner side and an outer end either
opening laterally outwardly into the gas-discharge passage in a predetermined angular position of the plug or
opening outwardly into the exterior.

2. The battery cap defined in claim 1, wherein the plug is formed with a compartment forming a seat, the cap further comprising:
a filter body pervious to gas fitted in the compartment, whereby gas can only flow through the passage of the plug after flowing through the filter body.

3. The battery cap defined in claim 2, wherein in another angular position of the plug the passage does not communicate with the gas-discharge passage.

4. The battery cap defined in claim 1, further comprising:
a drop catcher on the inner side of the plug and formed with a labyrinthine passage through which gas must flow to enter the passage of the plug.

5. The battery cap defined in claim 1 wherein the gas-vent plug has a side wall with a laterally open gas port and has on its upper face at least one gas-outlet port and the gas-vent plug is rotatable in the battery cap between one angular position in which the gas port is open and another angular position in which the gas-outlet port is open.
